(19) United States
(12) Patent Application Publication
(10) Pub. No.: US 2009/0263710 A1
(43) Pub. Date: Oct. 22, 2009

(54) AA ALKALINE BATTERY

(76) Inventors: Fumio KATO, Osaka (JP); Jun Nunome, Kyoto (JP); Harunari Shimamura, Osaka (JP)

Correspondence Address: MCDERMOTT WILL & EMERY LLP, 600 13TH STREET, NW, WASHINGTON, DC, 20005-3096, US

(21) Appl. No.: 12/417,281

(22) Filed: Apr. 2, 2009

(30) Foreign Application Priority Data
Apr. 18, 2008 (JP) 2008-109361

(51) Int. Cl. H01M 2/02

(52) U.S. Cl. 429/163

(57) ABSTRACT

In an AA alkaline battery, an opening of a battery case is sealed by a gasket. The battery case houses a positive electrode, a negative electrode, a separator, and an alkaline electrolyte. The positive electrode contains manganese dioxide having a potential of higher than or equal to 270 mV measured by using mercurous oxide (Hg/HgO) as a reference electrode in 40 wt % of a potassium hydroxide aqueous solution. The negative electrode contains 4.0 g or more of zinc. The gasket has a hydrogen gas permeability coefficient, per one gasket, in the range from 6×10⁻¹⁰ (cm³H₂(STP)/sec·cmHg) to 3×10⁻⁹ (cm³H₂(STP)/sec·cmHg), both inclusive.

### CROSS-REFERENCE TO RELATED APPLICATION

This application claims priority from Japanese Patent Application No. JP2008-109361 filed on Apr. 18, 2008, which is hereby incorporated by reference in its entirety for all purposes.

### BACKGROUND

The present disclosure relates to AA alkaline batteries.

In recent years, alkaline batteries have been required to have higher power. To meet this requirement, it has been proposed to use, as a positive electrode active material, manganese dioxide having higher potential than conventional manganese dioxide.

For example, International Publication WO 01/011703 discloses a technique for extending the life of an alkaline battery by employing a positive electrode containing electrolytic manganese dioxide having a potential of at least about 0.860 V at pH=6.

In addition, Japanese Laid-Open Patent Publication No. 2002-348693 discloses a technique of incorporating, in a positive electrode of an alkaline battery, manganese dioxide powder having a high potential in an alkaline electrolyte and having high filling ability so as to increase the battery capacity of the alkaline battery.

### SUMMARY

Manganese dioxide having a higher potential than conventional manganese dioxide is more reactive than conventional manganese dioxide, and hence causes deterioration of storage characteristics (i.e., the ability of retaining initial discharge performance during storage) of an alkaline battery.

An example AA alkaline battery of this disclosure includes: a battery case having an opening; and a gasket configured to seal the opening. The battery case houses a positive electrode containing manganese dioxide, a negative electrode, a separator provided between the positive electrode and the negative electrode, and an alkaline electrolyte. The manganese dioxide contained in the positive electrode has a potential of higher than or equal to 270 mV when measured by using mercurous oxide (Hg/HgO) as a reference electrode in 40 wt % of a potassium hydroxide aqueous solution. The negative electrode contains 4.0 g or more of zinc. The gasket has a hydrogen gas permeability coefficient, per one gasket, in the range from 6×10⁻¹⁰ (cm³H₂(STP)/sec·cmHg) to 3×10⁻⁹ (cm³H₂(STP)/sec·cmHg), both inclusive.

In such a structure, the negative electrode contains a larger amount of zinc than a conventional negative electrode. As a result, the capacity of the AA alkaline battery can be increased.

The manganese dioxide as a positive electrode active material has a higher potential than conventional manganese dioxide. As a result, the power of the AA alkaline battery can be increased.

In addition, hydrogen gas generated in the AA alkaline battery is released to outside the battery through the gasket. As a result, storage characteristics of the AA alkaline battery can be enhanced. This enhancement will be specifically described later. Further, the release of the hydrogen gas to outside the AA alkaline battery causes no breakage of the gasket. As a result, the leakage resistance of the AA alkaline battery can also be increased.

Preferably, in the AA alkaline battery, the zinc contained in the negative electrode includes zinc particles having diameters of smaller than or equal to 75 μm, and the weight ratio of the zinc particles is in the range from 20 wt % to 50 wt %, both inclusive, of the weight of the zinc contained in the negative electrode. Then, the surface area of the negative electrode can be increased. As a result, the power of the AA alkaline battery can be further increased. In addition, the productivity of the AA alkaline battery can also be enhanced.

In the AA alkaline battery, an internal space of the battery case preferably has a volume smaller than or equal to 0.3 cm³. Such a configuration in which the internal space of the battery case has a smaller volume than that in a conventional battery means that components such as the positive electrode active material, the negative electrode active material, and the alkaline electrolyte are more highly densely housed in the battery case than in the conventional battery. As a result, the capacity of the AA alkaline battery can be increased.

In the AA alkaline battery, the alkaline electrolyte in the battery case preferably has a total weight of larger than or equal to 4.0 g. Then, the power of the AA alkaline battery can be further increased.

In a preferred embodiment described later, the positive electrode includes, as an active material, only the manganese dioxide having a potential of higher than or equal to 270 mV in a case where mercurous oxide (Hg/HgO) is used as a reference electrode in 40 wt % of the potassium hydroxide aqueous solution.

In another preferred embodiment described later, the gasket is made of nylon 6-12.

### BRIEF DESCRIPTION OF THE DRAWINGS

FIG. 1 is a half sectional view illustrating a structure of an AA alkaline battery according to an embodiment of the present invention.

FIG. 2 is an enlarged view showing a portion II in FIG. 1.

FIG. 3 is an enlarged view showing a portion III in FIG. 2.

FIG. 4 is a graph showing variations of open circuit voltages in AA alkaline batteries according to Example and Comparative Example.

### DETAILED DESCRIPTION

Prior to the description of an embodiment of the present invention, it is described what inventors of the present invention have examined.

It was found that when manganese dioxide having a higher potential than conventional manganese dioxide is used as a positive electrode active material in order to increase the power of an AA alkaline battery, storage characteristics of this AA alkaline battery deteriorate. It was also found that when the loading weight of zinc is made larger than that in a conventional battery in order to increase the capacity as well as the power of an AA alkaline battery, storage characteristics of the AA alkaline battery greatly deteriorate. The inventors thought that this is because of the following reasons:

It is known that in a hydrogen atmosphere, manganese dioxide generally causes reduction reaction expressed by Equation 1:

2MnO₂+H₂→MnOOH (1)

This reduction reaction is more likely to occur in manganese dioxide having higher potential.

In an AA alkaline battery, zinc (i.e., a negative electrode active material) is in contact with a strong alkaline aqueous solution (i.e., an alkaline electrolyte), thus generating hydrogen gas. Therefore, as the shelf time of an AA alkaline battery increases, the hydrogen partial pressure in the battery increases. Thus, in a situation where an AA alkaline battery in which manganese dioxide having a higher potential than conventional manganese dioxide is used as a positive electrode active material is stored for a long time, the hydrogen partial pressure in the battery increases as the shelf time of the battery increases, causing the reduction reaction expressed by Equation 1 to proceed. Consequently, manganese dioxide deteriorates. The deterioration of manganese dioxide makes it difficult to retain initial discharge characteristics of the AA alkaline battery. This is considered to cause deterioration of storage characteristics of the AA alkaline battery.

In addition, if the loading weight of zinc is made larger than that in a conventional battery, on one hand, the amount of generated hydrogen gas becomes larger, and on the other hand, the space in a battery case becomes smaller than in the conventional battery. Accordingly, the hydrogen partial pressure in the AA alkaline battery further increases. This increase might be accelerated in some cases. Consequently, manganese dioxide further deteriorates, resulting in difficulty in retaining initial discharge characteristics of the AA alkaline battery. This is considered to cause further deterioration of the storage characteristics of the AA alkaline battery.

To retain storage characteristics of an AA alkaline battery, it is sufficient to suppress reduction of manganese dioxide in a hydrogen atmosphere. In view of this, the inventors came up with an idea of releasing generated hydrogen gas to outside the AA alkaline battery.

For example, Japanese Laid-Open Patent Publication No. 11-250875 (hereinafter, referred to as “Patent Document A”) discloses a gasket which is permeable to hydrogen gas. Such a gasket allows hydrogen gas generated in an AA alkaline battery to pass through the gasket and to be released to outside the AA alkaline battery. Therefore, it appears that an increase of the hydrogen partial pressure in the battery is suppressed and, accordingly, reduction of manganese dioxide is prevented.

In view of this, the inventors evaluated storage characteristics of an AA alkaline battery employing a gasket disclosed in Patent Document A and using manganese dioxide having a higher potential than conventional manganese dioxide as a positive electrode active material. However, even the use of the gasket disclosed in Patent Document A could not sufficiently suppress deterioration of storage characteristics of the AA alkaline battery. From this result, the inventors concluded as follows:

According to fluid mechanics, the amount of hydrogen gas passing through a gasket is expressed by Equation 2:

(the amount of hydrogen gas permeation)=k×(Pf−Pi)×(S/d) (2)

where k is a coefficient depending on a material for the gasket, Pi is an internal pressure of a battery, Pf is a pressure outside the battery, and d is the thickness of a portion of the gasket through which hydrogen gas passes. The gasket has a thinner portion, and most part of hydrogen gas is considered to pass through this thinner portion. Therefore, d is the thickness of the thinner portion of the gasket. In Equation 2, S is the cross-sectional area of the thinner portion of the gasket along the direction vertical to the thickness of the gasket.

Equation 2 shows that the amount of hydrogen gas permeation is proportional to the coefficient k, is proportional to the cross-sectional area S of the thinner portion of the gasket, and is inversely proportional to the thickness d of the thinner portion of the gasket. Patent Document A only specifies the hydrogen permeability of the material for a gasket, i.e., only specifies the coefficient k in Equation 2. Accordingly, even if the gasket is made of a material having a high coefficient k, the amount of hydrogen gas permeation is small as long as the thinner portion of the gasket has a small cross-sectional area S or has a large thickness. In contrast, even though the coefficient k in Equation 2 is not so high, when the cross-sectional area S of the thinner portion of the gasket is increased or the thickness of the thinner portion of the gasket is reduced, the amount of hydrogen gas permeation is increased.

From the foregoing fact, the inventors expected that the design of a gasket capable of obtaining a sufficient amount of hydrogen gas permeation would suppress reduction reaction of manganese dioxide expressed by Equation 1, and completed the present invention. Hereinafter, an embodiment of the present invention will be specifically described with reference to the drawings. It should be noted that the present invention is not limited to the following embodiment.

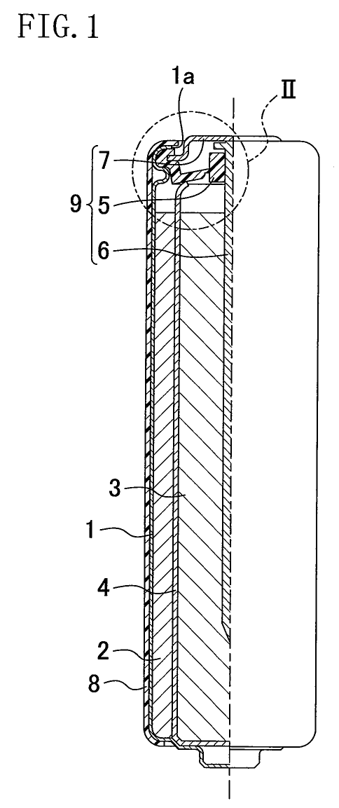

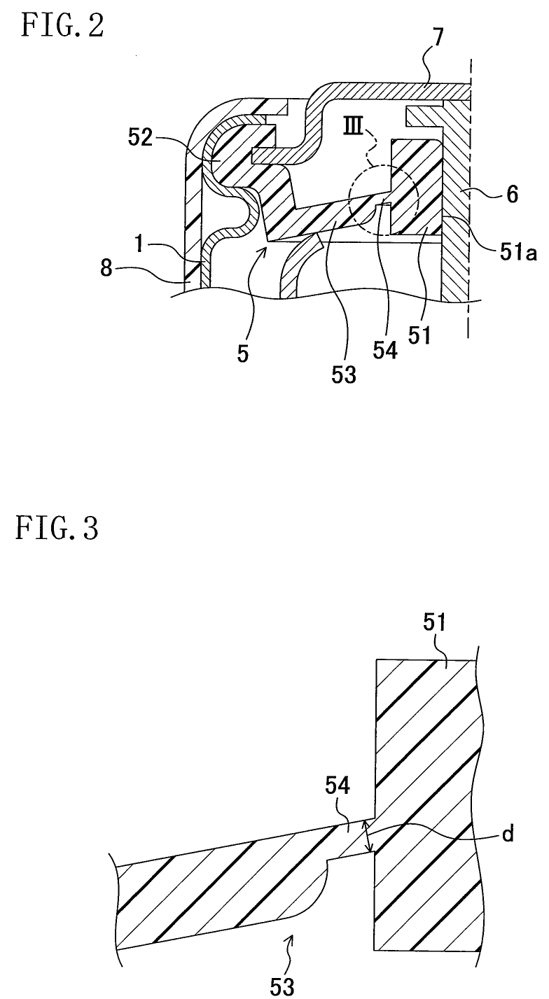

FIG. 1 is a half sectional view illustrating an AA alkaline battery according to an embodiment of the present invention. FIG. 2 is an enlarged view showing a portion II in FIG. 1. FIG. 3 is an enlarged view showing a portion III in FIG. 2.

As illustrated in FIG. 1, the AA alkaline battery of this embodiment includes a cylindrical battery case 1 which is sealed at one end (i.e., at the lower end in FIG. 1). The outer surface of the battery case 1 is covered with an exterior label 8. The battery case 1 serves as a positive electrode terminal and a positive electrode current collector. A hollow cylindrical positive electrode 2 is inscribed in the battery case 1. A separator 4 is provided in the hollow portion of the positive electrode 2, and is formed in the shape of a cylinder which is sealed at one end. A negative electrode 3 is placed in the hollow portion of the separator 4. Accordingly, the battery case 1 is configured such that the positive electrode 2, the separator 4, and the negative electrode 3 are arranged in this order from the periphery to the center of the battery case 1.

An opening 1a (i.e., the upper end in FIG. 1) of the battery case 1 is sealed by an assembled sealing unit 9. The assembled sealing unit 9 is configured by integrating a nail-shaped negative electrode current collector 6, a negative electrode terminal plate 7, and a gasket 5. The negative electrode terminal plate 7 is electrically connected to the negative electrode current collector 6. The gasket 5 is fixed to the negative electrode current collector 6 and the negative electrode terminal plate 7.

The battery case 1 is obtained by, for example, press-molding a nickel-coated steel plate into a predetermined shape having predetermined dimensions with a known method disclosed in, for example, Japanese Laid-Open Patent Publications Nos. 60-180058 and 11-144690.

The positive electrode 2 contains a mixture of a positive electrode active material such as electrolytic manganese dioxide powder, a conductive agent such as graphite powder, and an alkaline electrolyte. A binder such as polyethylene powder or a lubricant such as stearate may be added to the positive electrode 2 as necessary.

The negative electrode 3 is obtained by, for example, adding a gelling agent such as sodium polyacrylate to the alkaline electrolyte and dispersing zinc alloy particles in the resultant gelled alkaline electrolyte. To increase the corrosion resistance of the negative electrode 3, a metal compound, such as indium or bismuth, having a high hydrogen overvoltage may be added to the negative electrode 3 as necessary. To suppress zinc dendrite formation, a trace amount of a silicon compound such as silicic acid or silicate may be added to the negative electrode 3 as necessary.

As the separator 4, nonwoven fabric obtained by mainly mixing polyvinyl alcohol fiber and rayon fiber is used, for example. The separator 4 is obtained by a known method disclosed in, for example, Japanese Laid-Open Patent Publications Nos. 6-163024 and 2006-32320.

The gasket 5 includes a center portion 51, a peripheral portion 52, and a connecting portion 53. The center portion 51 is a cylindrical member provided at the center of the opening 1a of the battery case 1, and has a through hole 51a extending along the length of the battery case 1. The negative electrode current collector 6 is inserted into the through hole 51a. The peripheral portion 52 is a cylindrical member provided at the periphery of the opening 1a of the battery case 1 (specifically, provided between the negative electrode terminal plate 7 and the inner wall of the battery case 1). The connecting portion 53 connects the center portion 51 and the peripheral portion 52 to each other, and has a thinner portion 54. The thinner portion 54 is thinner than the other portion of the connecting portion 53, the center portion 51, and the peripheral portion 52.

The negative electrode current collector 6 is obtained by press-molding a wire material of, for example, silver, copper, or brass into a nail shape having predetermined dimensions. During this molding, an impurity might be mixed. In such a case, to eliminate the impurity or shield the negative electrode current collector 6 from the impurity, the surface of the negative electrode current collector 6 is preferably plated with tin or indium, for example.

The negative electrode terminal plate 7 includes a terminal portion for sealing the opening 1a of the battery case 1 and a circumferential flange portion. The circumferential flange portion extends from the terminal portion, and is in contact with the gasket 5. The circumferential flange portion has a plurality of gas holes (not shown) for reducing the internal pressure of the AA alkaline battery when the safety valve of the gasket 5 is actuated. The negative electrode terminal plate 7 is obtained by, for example, press-molding a nickel-coated or tin-coated steel plate into a predetermined shape having predetermined dimensions.

In general, in fabricating such an AA alkaline battery, components such as the positive electrode 2, the negative electrode 3, and the separator 4 are housed in the battery case 1, and then the opening 1a of the battery case 1 is covered with the assembled sealing unit 9.

Now, the positive electrode 2, the negative electrode 3, and the gasket 5 of this embodiment are described.

The positive electrode 2 of this embodiment contains manganese dioxide as a positive electrode active material. This manganese dioxide has a higher potential than conventional manganese dioxide. Specifically, manganese dioxide used in this embodiment has a potential of 270 mV or more when measured by using mercurous oxide (Hg/HgO) as a reference electrode in 40 wt % of a potassium hydroxide aqueous solution. The use of such manganese dioxide having a higher potential than conventional manganese dioxide can increase the power of the AA alkaline battery. The positive electrode 2 of this embodiment preferably contains only aforementioned manganese dioxide having a higher potential than conventional manganese dioxide as a positive electrode active material.

The negative electrode 3 of this embodiment contains a larger amount of zinc than a conventional negative electrode. Specifically, the negative electrode 3 of this embodiment contains 4.0 g or more of zinc, whereas the conventional negative electrode contains only about 3.8 g of zinc. Accordingly, the capacity of the AA alkaline battery of this embodiment can be increased.

In addition, zinc contained in the negative electrode 3 includes a larger amount of zinc particles having smaller diameters than those in a conventional negative electrode. Specifically, zinc particles having diameters of 75 μm or less are included. The weight ratio of the zinc particles are in the range from 20 wt % to 50 wt %, both inclusive. The fact that 20 wt % or more of zinc particles having diameters of 75 μm or less are included leads to an increase in the surface area of the negative electrode 3, thus further increasing the capacity of the AA alkaline battery. Further, the fact that 50 wt % or less of zinc particles having diameters of 75 μm or less are included allows the optimum viscosity and fluxionality of the gelled negative electrode to be maintained, thus facilitating fabrication of the battery.

The positive electrode 2, the negative electrode 3, and the separator 4 contain an alkaline electrolyte. This alkaline electrolyte contains 30 wt % to 40 wt % of potassium hydroxide and 1 wt % to 3 wt % of zinc oxide. The total weight of the alkaline electrolyte contained in the battery case 1 is larger than that in a conventional battery, and is 4.0 g or more, for example. Consequently, the power of the AA alkaline battery can be further increased.

In the AA alkaline battery of this embodiment, the loading weights of the negative electrode active material and the alkaline electrolyte are larger than those in a conventional battery. Accordingly, the space in the battery case 1 is smaller than that in the conventional battery, and is 3 cm³ or less, for example.

As described above, in the AA alkaline battery of this embodiment, manganese dioxide having a higher potential than conventional manganese dioxide is used as a positive electrode active material, and the loading weight of the alkaline electrolyte is larger than that in a conventional AA alkaline battery. As a result, the power of the battery can be increased. In addition, in the AA alkaline battery of this embodiment, the loading weight and surface area of zinc are larger than those in the conventional AA alkaline battery. As a result, the capacity of the AA alkaline battery can be increased.

It is expected that the use of manganese dioxide having a higher potential than conventional manganese dioxide as a positive electrode active material would cause deterioration of storage characteristics of an AA alkaline battery as described above. It is also expected that an increase in the capacity as well as the power of an AA alkaline battery, as in the case of the AA alkaline battery of this embodiment, would cause further deterioration of storage characteristics of the AA alkaline battery. However, the gasket 5 of this embodiment is designed to be permeable to hydrogen. Accordingly, in the AA alkaline battery of this embodiment, even when hydrogen gas is generated, and moreover, even when the amount of hydrogen gas generation due to an increase in capacity increases, the generated hydrogen gas passes through the gasket 5 to be released to outside the battery. Consequently, an increase of hydrogen partial pressure resulting from a long-term storage is suppressed in the AA alkaline battery of this embodiment. Thus, even when manganese dioxide having a higher potential than conventional manganese dioxide is used as a positive electrode active material, reduction of this manganese dioxide is suppressed, thus suppressing deterioration of storage characteristics. The suppression of deterioration of storage characteristics is more remarkably exhibited by increasing both power and capacity than by increasing only power. Then, the gasket 5 of this embodiment is described.

The gasket 5 of this embodiment is designed in such a manner that the hydrogen gas permeability coefficient per one gasket is in the range from 6×10⁻¹⁰ (cm³H₂(STP)/sec·cmHg) to 3×10⁻⁹ (cm³H₂(STP)/sec·cmHg), both inclusive. The hydrogen gas permeability coefficient per one gasket depends on both the material and shape of the gasket 5, and is expressed as k×(S/d) in Equation 2. A sufficient amount of hydrogen gas permeation through the gasket 5 is assured as long as the hydrogen gas permeability coefficient per one gasket 5 is within the above range. Accordingly, the AA alkaline battery of this embodiment can be stored for a long time without an increase in hydrogen partial pressure inside the battery case 1. In addition, hydrogen gas is allowed to be released to outside the AA alkaline battery of this embodiment without breakage of the gasket 5. As a result, the leakage resistance can be increased.

It is not preferable that the hydrogen gas permeability coefficient per one gasket 5 is less than 6×10⁻¹⁰ (cm³H₂(STP)/sec·cmHg) because it is difficult to assure that a sufficient amount of hydrogen gas is permeated through the gasket 5, and therefore, deterioration of storage characteristics of the AA alkaline battery cannot be sufficiently suppressed. The hydrogen gas permeability coefficient per one gasket 5 is preferably as high as possible in order to assure a sufficient amount of hydrogen gas permeated through the gasket 5. However, hydrogen gas permeability coefficients per one gasket 5 exceeding 3×10⁻⁹ (cm³H₂(STP)/sec·cmHg) are not preferable because hydrogen gas released from an AA alkaline battery might fill airtight apparatus in which the AA alkaline battery is incorporated.

Specifically, the gasket 5 is preferably made of a material having high hydrogen gas permeability. Preferably, the thinner portion 54 has a large cross-sectional area (S) and a small thickness (d). In other words, the material having high hydrogen gas permeability is a material having a high coefficient k in Equation 2, and is nylon 6-12, for example.

As the cross-sectional area (S) of the thinner portion 54 increases, the amount of hydrogen gas permeation increases, thus sufficiently suppressing deterioration of storage characteristics of the AA alkaline battery. However, an excessively large cross-sectional area (S) of the thinner portion 54 is unpreferable because the thinner portion 54 might be broken at a rise of the internal pressure of the AA alkaline battery, resulting in a reduction in the leakage resistance of the AA alkaline battery. Further, when the thinner portion 54 has an excessively large cross-sectional area (S), the thinner portion 54 occupies a large part of the gasket 5, and the center portion 51 and the peripheral portion 52 occupy small parts of the gasket 5 accordingly, resulting in failures in functions of the center portion 51 and the peripheral portion 52 of the gasket 5. For example, it may become difficult to firmly hold the negative electrode current collector 6 in the through hole 51a of the center portion 51, or it may become difficult to fix the gasket 5 to the battery case 1. From the foregoing consideration, the cross-sectional area (S) of the thinner portion 54 is 0.04 cm² or more, and is preferably in the range from 0.04 cm² to 0.2 cm², both inclusive.

As the thickness (d) of the thinner portion 54 decreases, hydrogen gas passes through the gasket 5 more easily, and thus the amount of hydrogen gas permeation increases, resulting in sufficiently suppressing deterioration of storage characteristics of the AA alkaline battery. However, an excessively small thickness (d) of the thinner portion 54 is unpreferable because the thinner portion 54 might be broken in forming the gasket 5, and thus the yield of the gasket 5 decreases. In addition, when the thickness (d) of the thinner portion 54 is excessively small, the thinner portion might be broken upon an increase in the internal pressure of the AA alkaline battery, resulting in a reduction in the leakage resistance of the AA alkaline battery. From the foregoing consideration, the inventors concluded that the thickness (d) of the thinner portion 54 is preferably in the range from 0.12 mm to 0.25 mm, both inclusive.

As described above, in this embodiment, manganese dioxide having a higher potential than conventional manganese dioxide is used as a positive electrode active material, and the loading weight of zinc is larger than that in a conventional battery. Accordingly, the power and capacity of the AA alkaline battery can be increased. In addition, the increase in power and capacity involves an increase in the amount of hydrogen gas generation. However, generated hydrogen gas passes through the gasket 5 to be released to outside the battery case 1. Consequently, reduction of manganese dioxide in a hydrogen atmosphere is prevented. Accordingly, even when the positive electrode active material is made of manganese dioxide having a higher potential than conventional manganese dioxide, the AA alkaline battery can be stored without deterioration of the manganese dioxide. As a result, in the AA alkaline battery of this embodiment, the power and capacity can be increased, and deterioration of storage characteristics can be suppressed.

Moreover, hydrogen gas can be released to outside the battery case 1 without breakage of the gasket 5. As a result, the leakage resistance of the AA alkaline battery can be increased.

In this embodiment, the shape of the gasket 5 is not limited to the shape illustrated in FIG. 2.

### EXAMPLE

An example of this disclosure is now described. In Example, as a preliminary examination, the hydrogen gas permeability coefficient (i.e., the coefficient k in Equation 2) of nylon resin (which is a material for a gasket) was measured by using a sheet of this nylon resin. In addition, an AA alkaline battery was fabricated according a method described below, and then the AA alkaline battery was stored at high temperature, and the voltage behavior and discharge characteristics were examined.

### (Preliminary Examination)

The hydrogen gas permeability coefficient (i.e., the coefficient k in Equation 2) of nylon resin as a material for a gasket was measured using a sheet (having a thickness of about 0.7 mm) of this nylon resin with a differential pressure method conforming to JIS K7176-1. The hydrogen gas permeability coefficient (i.e., the coefficient k in Equation 2) of the nylon resin was measured under conditions shown in Table 1:

TABLE 1

| | |
|---|---|
| Measurement | differential pressure gas/vapor permeability |
| equipment | measurement equipment GTR-30X produced by |
| | GTR Tech Corporation |
| Detector | gas chromatograph (thermal conductivity detector) |
| Permeation area | 1.52 × 10⁻³ m² (diameter φ: 4.4 × 10⁻² m) |
| Permeated gas | hydrogen gas in a humidified atmosphere of 90% RH |
| Temperature | 25 ± 2° C. |
| Differential | 1 atm |
| pressure | (hydrogen partial pressure: 73.86 cmHg |
| | water vapor partial pressure: 2.14 cmHg) |

As a gasket, a gasket of nylon 6-12 was used in Example, whereas a gasket of nylon 6-6 was used in Comparative Example, as described later. Nylon 6-12 and nylon 6-6 were selected as nylon resin so as to measure the hydrogen gas permeability coefficient (i.e., the coefficient k in Equation 2) for each example. Then, the hydrogen gas permeability coefficient (i.e., the coefficient k in Equation 2) of nylon 6-12 was 1.06×10⁻¹⁰ (cm³H₂(STP)·cm/cm²·sec·cmHg), and the hydrogen gas permeability coefficient (i.e., the coefficient k in Equation 2) of nylon 6-6 was 3.39×10⁻¹¹ (cm^{3 1 H}_{2 (STP)·cm//cm}²·sec·cmHg).

### (Method for Fabricating AA Alkaline Battery According to Example)

First, zinc alloy powder containing 0.005 wt % of Al, 0.005 wt % of Bi, and 0.020 wt % of In with respect to the weight of zinc was prepared by a gas atomizing method. Then, this zinc alloy powder was classified with a screen. With this classification, zinc alloy powder was adjusted in such a manner that the zinc alloy powder had a grain size ranging from 70 to 300 meshes, and that the ratio of zinc alloy powder having a grain diameter of 200 meshes (i.e., 75 μm) or less was 30% of the whole zinc alloy powder. In this manner, a negative electrode active material was obtained.

Next, polyacrylic acid and sodium polyacrylate were added to, and mixed with, 100 weight parts of 34.5 wt % of a potassium hydroxide aqueous solution (containing 2 wt % of ZnO) in such a manner that the total mass was 2.2 weight parts, and the resultant mixture was made into gel, thereby obtaining a gelled electrolyte. Thereafter, this gelled electrolyte was left alone for 24 hours to be sufficiently matured.

Then, the zinc alloy particles in an amount 2.00 times as much as a given amount of the gelled electrolyte in weight ratio were added to, and sufficiently mixed with, the gelled electrolyte, thereby obtaining a gelled negative electrode.

Thereafter, electrolytic manganese dioxide (HHTF: a product by TOSOH CORPORATION) and graphite (SP-20: a product by Nippon Graphite Industries, ltd.) were blended at a weight ratio of 94:6, thereby obtaining mixed powder. With 100 weight parts of this mixed powder, 1.5 weight parts of an electrolyte (e.g., 39 wt % of a potassium hydroxide aqueous solution containing 2 wt % of ZnO) and 0.2 weight part of a polyethylene binder were mixed. Then, the mixture was uniformly stirred and mixed by a mixer, and was sized to have a given grain size. The obtained grain substance was press formed into a hollowed cylindrical shape. In this manner, a positive electrode mixture in the form of a pellet was obtained.

The potential of electrolytic manganese dioxide was measured according to the following method: First, 5 ml of 40 wt % of a KOH aqueous solution was added to 2 g of electrolytic manganese dioxide powder, thereby obtaining mixture slurry. Then, the potential of this mixture slurry with respect to a reference electrode (mercury/mercurous oxide) was measured in an atmosphere of 20° C. This measurement shows that the mixture slurry had a potential of 280 mV with respect to the reference electrode (mercury/mercurous oxide).

The potential of electrolytic manganese dioxide may be measured by the aforementioned method, or by the following method: In this method, an AA alkaline battery (product) is fabricated, and then the potential of electrolytic manganese dioxide is measured. To measure the potential, the battery case is partially opened to obtain a liquid junction with 40 wt % of a KOH aqueous solution, and the potential of the positive electrode with respect to the reference electrode (mercury/mercurous oxide) in an atmosphere of 20° C.

Subsequently, a sample AA alkaline battery was prepared. Specifically, as illustrated in FIG. 1, two pellets of the positive electrode mixture (weight: 5.15 g per one pellet) obtained above were inserted into the battery case 1, and pressure was applied again to the pellets in the battery case 1, thereby bringing the pellets into close contact with the inner surface of the battery case 1. Then, a separator 4 and a bottom insulator for insulating the bottom of the battery case 1 were placed inside the positive electrode mixture pellets. Thereafter, 1.5 g of an electrolyte (e.g., 34.5 wt % of a potassium hydroxide aqueous solution containing 2 wt % of ZnO) was injected. After the injection, the inside of the separator 4 was filled with 6.2 g of a gelled negative electrode 3 (containing 4.1 g of zinc alloy particles). Subsequently, the opening 1a of the battery case 1 was sealed by an assembled sealing unit 9 formed by integrating a gasket 5, a negative electrode current collector 6, and a negative electrode terminal plate 7. Specifically, the negative electrode current collector 6 was inserted in the negative electrode 3, and the circumferential flange portion of the negative electrode terminal plate 7 was crimped to the rim of the opening 1a of the battery case 1 with the peripheral portion 52 of the gasket 5 interposed therebetween, thereby bringing the negative electrode terminal plate 7 into close contact with the opening 1a of the battery case 1. Then, the outer surface of the battery case 1 was covered with an exterior label 8, thus completing an AA alkaline battery according to Example.

The gasket 5 was formed using nylon 6-12 with an injection-molding method. The gasket 5 has a thinner portion 54 whose cross-sectional area (S) was 0.071 cm² and thickness (d) was 0.24 mm. In consideration of data (i.e., the value of the coefficient k) on the preliminary example described above, this design provided a hydrogen gas permeability coefficient [k×(S/d)] of 3.1×10⁻¹⁰ (cm³H₂(STP)/sec·cmHg) per one gasket of nylon 6-12 used in Example.

As the negative electrode current collector 6, a brass wire plated with Sn was used. As the separator 4, an alkaline battery separator (i.e., a composite fiber made of vinylon and tencel®) produced by KURARAY CO., LTD. was used.

### COMPARATIVE EXAMPLE

In Comparative Example, nylon 6-6 was used as a material for a gasket formed by injection-molding. The other conditions were the same as the method for fabricating an AA alkaline battery of Example, including the thickness and cross-sectional area of the thinner portion of the gasket. In this manner, an AA alkaline battery according to Comparative Example was fabricated.

In consideration of the results of the preliminary examination, the hydrogen gas permeability coefficient [k×(S/d)] per one nylon 6-6 gasket of Comparative Example was calculated to be 0.99×10⁻¹⁰ (cm³H₂(STP)/sec·cmHg).

### (Battery Evaluation)

For each of Example and Comparative Example, five new batteries were left alone for eight weeks in a constant-temperature atmosphere of 60° C., and the open circuit voltage (OCV) was measured every other week. After the eight weeks, each of the batteries was continuously discharged (end voltage: 0.9 V) with 100 mA in an atmosphere of 20° C., and the time (discharge duration) necessary for the voltage to fall below 0.9 V was measured. Using these two types of measurement results, discharge characteristics after storage of the AA alkaline batteries were evaluated. A storage test in which batteries are left alone for eight weeks in a constant-temperature atmosphere of 60° C. is an accelerated evaluation corresponding to storage for about five to six years at room temperature.

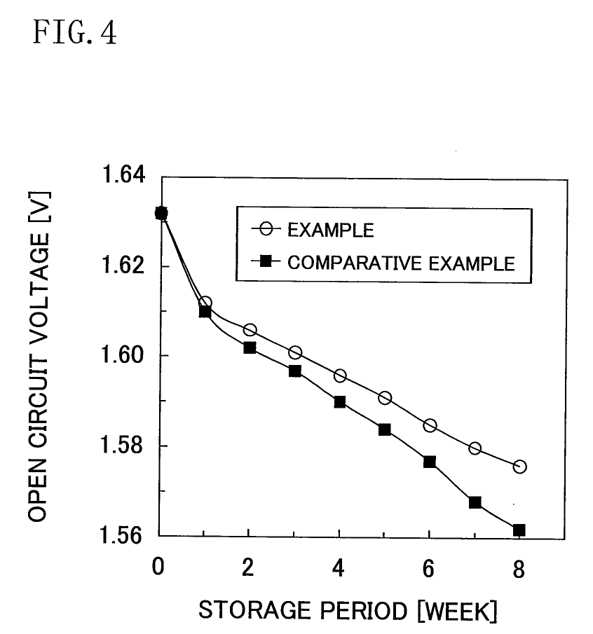

As a result, as shown in FIG. 4, a variation (an average value of five batteries) in the open circuit voltage of the AA alkaline batteries of Example was smaller than that in the AA alkaline batteries of Comparative Example. With respect to discharge characteristics (an average value of five batteries) after storage of an AA alkaline battery at 60° C. for eight weeks, suppose the discharge duration of the batteries of Comparative Example was 100, the discharge duration of the batteries of Example was 110.

It is estimated that this difference arises because of the mechanism described in the above embodiment. Specifically, the gasket used in Example has a higher hydrogen gas permeability coefficient per one gasket than the gasket used in Comparative Example. Accordingly, the AA alkaline battery of Example is considered to suppress an increase of the hydrogen partial pressure within the battery, as compared to the AA alkaline battery of Comparative Example, resulting in suppressing deterioration of manganese dioxide having a higher potential than conventional manganese dioxide.

What is claimed is:

1. An AA alkaline battery, comprising:
a battery case having an opening; and
a gasket configured to seal the opening, wherein the battery case houses a positive electrode containing manganese dioxide, a negative electrode, a separator provided between the positive electrode and the negative electrode, and an alkaline electrolyte,
the manganese dioxide contained in the positive electrode has a potential of higher than or equal to 270 mV when measured by using mercurous oxide (Hg/HgO) as a reference electrode in 40 wt % of a potassium hydroxide aqueous solution,
the negative electrode contains 4.0 g or more of zinc, and
the gasket has a hydrogen gas permeability coefficient, per one gasket, in the range from 6×10⁻¹⁰ (cm³H₂(STP)/sec·cmHg) to 3×10⁻⁹ (cm³H₂(STP)/sec·cmHg), both inclusive.

2. The AA alkaline battery of claim 1, wherein the zinc contained in the negative electrode includes zinc particles having diameters of smaller than or equal to 75 μm, and the weight ratio of the zinc particles is in the range from 20 wt % to 50 wt %, both inclusive, of the weight of the zinc contained in the negative electrode.

3. The AA alkaline battery of claim 1, wherein an internal space of the battery case has a volume smaller than or equal to 0.3 cm³.

4. The AA alkaline battery of claim 1, wherein the alkaline electrolyte in the battery case has a total weight of larger than or equal to 4.0 g.

5. The AA alkaline battery of claim 1, wherein the positive electrode includes, as an active material, only the manganese dioxide having a potential of higher than or equal to 270 mV measured by using the manganese dioxide (Hg/HgO) as a reference electrode in 40 wt % of the potassium hydroxide aqueous solution.

6. The AA alkaline battery of claim 1, wherein the gasket is made of nylon 6-12.
